(19) United States
(12) Patent Application Publication
(10) Pub. No.: US 2021/0399439 A1
(43) Pub. Date: Dec. 23, 2021

(54) COMMUNICATION SYSTEM

(71) Applicant: HONDA MOTOR CO., LTD., Minato-ku, Tokyo (JP)

(72) Inventor: Koki Kubo, Wako-shi (JP)

(21) Appl. No.: 17/289,760

(22) PCT Filed: Nov. 9, 2018
(86) PCT No.: PCT/JP2018/041594

§ 371 Date: Apr. 29, 2021

(51) Int. Cl. H01Q 21/28; H04B 1/00; H04B 1/3822; H01Q 1/32

(52) U.S. Cl. CPC H01Q 21/28; H01Q 1/32; H04B 1/3822; H04B 1/0064

(57) ABSTRACT

An antenna unit includes a first antenna unit and a second antenna unit. The first antenna unit includes a first antenna for wireless communication in a first frequency band and a second antenna for wireless communication in a second frequency band. The second antenna unit includes the first antenna for wireless communication in the first frequency band and a third antenna for wireless communication in a third frequency band.

### TECHNICAL FIELD

The present invention relates to a communication system.

### BACKGROUND

In the related art, a vehicle communication device that includes a plurality of antennas for mobile communication and an antenna for receiving a positioning signal is disclosed (for example, refer to Patent Document 1).

### RELATED ART DOCUMENTS

### Patent Documents

[Patent Document 1] Japanese Unexamined Patent Application, First Publication No. 2015-147509

### SUMMARY OF INVENTION

### Problems to be Solved by the Invention

In the vehicle communication device according to the related art described above, when a plurality of different antennas are mounted, it is desired to prevent the size of the entire unit from being increased.

In view of the foregoing, an object of the present invention is to provide a communication system capable of preventing the size of the entire unit from being increased.

### Means for Solving the Problem

In order to solve the problem described above and achieve such an object, the present invention employs the following aspects.

(1) A communication system according to an aspect of the present invention is a communication system that includes: a first unit including a first antenna for wireless communication in a first frequency band and a second antenna for wireless communication in a second frequency band; and a second unit including a first antenna for wireless communication in the first frequency band and a third antenna for wireless communication in a third frequency band, wherein only the second unit includes the third antenna.

(2) A communication system according to an aspect of the present invention is a communication system that includes: a first unit including a first antenna for wireless communication in a first frequency band and a second antenna for wireless communication in a second frequency band; and a second unit including a third antenna for wireless communication in the first frequency band and a third frequency band, wherein all antennas for wireless communication in the third frequency band are the third antenna.

(3) In the communication system described in (1) or (2) described above, the third frequency band may be lower than the first frequency band and the second frequency band.

(4) In the communication system described in any one of (1) to (3) described above, an application of wireless communication in the first frequency band may be common to an application of wireless communication in the third frequency band, and an application of wireless communication in each of the first frequency band and the third frequency band may be different from an application of wireless communication in the second frequency band.

(5) In the communication system described in (4) described above, the application of wireless communication in each of the first frequency band and the third frequency band may be cellular communication, and the application of wireless communication in the second frequency band may be a positioning signal communication.

(6) In the communication system described in (4) or (5) described above, the wireless communication in each of the first frequency band and the third frequency band may be bidirectional communication, and the wireless communication in the second frequency band may be only reception.

(7) In the communication system described in (1) described above, the number of the first antennas of the first unit may be equal to the number of the first antennas of the second unit.

(8) In the communication system described in (1) described above, the number of the first antennas of the first unit may be larger than the number of the first antennas of the second unit.

(9) In the communication system described in (1) described above, the number of the first antennas of the first unit may be smaller than the number of the first antennas of the second unit.

(10) In the communication system described in (2) described above, the number of the first antennas of the first unit may be equal to a number of the third antennas of the second unit.

(11) In the communication system described in (2) described above, the number of the first antennas of the first unit includes may be larger than the number of the third antennas of the second unit.

(12) In the communication system described in (2) described above, the number of the first antennas of the first unit may be smaller than the number of the third antennas of the second unit.

(13) In the communication system described in above (7), the wireless communication in the first frequency band may be a multiple I/O transmission in which a total number of antennas required for each of transmission and reception sides is four, the wireless communication in the third frequency band may be a multiple I/O transmission in which a total number of antennas required for each of transmission and reception sides is two, a total number of the first antennas that the first unit includes may be two, a total number of the first antennas that the second unit includes may be two, and a total number of the third antennas that the second unit includes may be two.

(14) In the communication system described in (10) described above, the wireless communication in the first frequency band may be a multiple I/O transmission in which a total number of antennas required for each of transmission and reception sides is four, the wireless communication in the third frequency band may be a multiple I/O transmission in which a total number of antennas required for each of transmission and reception sides is two, a total number of the first antennas that the first unit includes may be two, and a total number of the third antennas that the second unit includes may be two.

(15) In the communication system described in any one of (1) to (14) described above, the first unit may be arranged inside a vehicle.

(16) In the communication system described in (15) described above, the first unit may be arranged inside an instrument panel of the vehicle.

(17) In the communication system described in (15) or (16) described above, the second unit may be arranged on an exterior member of the vehicle.

### Advantage of the Invention

According to the communication system according to the aspect described in (1) described above, the first antenna is arranged on the first unit and the second unit, and the third antenna is arranged on the second unit. That is, in a case where the first unit and the second unit are constituted, for example, on the basis of the size and the shape of each antenna in accordance with the frequency band of wireless communication, the application of each antenna, and the like, the first antennas which are preferably distributed to each unit and the third antennas which are preferably concentrated to one unit can be arranged in a distinguished manner, and the first antenna can be preferably combined with the second antenna. Thereby, it is possible to prevent the size of the first unit and the second unit as a whole from being increased and to improve a layout efficiency.

Further, for example, in comparison with a case where the third antenna is distributed to each unit, it is possible to prevent the size of the first unit and the second unit as a whole from being increased and to improve the layout efficiency.

According to the communication system according to the aspect described in (2) described above, the first antenna together with the second antenna is arranged on the first unit, and the third antenna is arranged on the second unit. That is, in a case where the first unit and the second unit are constituted, for example, on the basis of the size and the shape of each antenna in accordance with the frequency band of wireless communication, the application of each antenna, and the like, the first antenna which is preferably combined with the second antenna and the third antennas which are preferably collected with the same kind can be arranged apart from each other. Thereby, it is possible to prevent the size of the first unit and the second unit as a whole from being increased and to improve a layout efficiency.

Further, for example, in comparison with a case where the third antenna is distributed to each unit, it is possible to prevent the size of the first unit and the second unit as a whole from being increased and to improve the layout efficiency.

Further, in the case of (3) described above, the size of the third antenna that corresponds to wireless communication of a lower frequency band than that of each of the first antenna and the second antenna is formed to be larger than each size of the first antenna and the second antenna. Accordingly, by collectively arranging the third antenna on one unit (that is, the second unit), for example, in comparison with a case where the third antennas are distributed to each unit, it is possible to improve the efficiency and the degree of freedom of a layout and to prevent the size of the first unit and the second unit as a whole from being increased.

Further, in the case of any of (4) to (6) described above, the second unit can be constituted of only antennas of a common application, and it is possible to improve the efficiency and the degree of freedom of a layout and to prevent the size of the first unit and the second unit as a whole from being increased.

Further, in the case of (7) described above, it is possible to optimize the size of both of the first unit and the second unit, and it is possible to improve the efficiency and the degree of freedom of a layout.

Further, in the case of (8) described above, in comparison with a case where the number of the first antennas in the first unit is equal to the number of the first antennas in the second unit, the second unit can be smaller, and it is possible to improve the efficiency and the degree of freedom of a layout.

Further, in the case of (9) described above, in comparison with a case where the number of the first antennas in the first unit is equal to the number of the first antennas in the second unit, the first unit can be smaller, and it is possible to improve the efficiency and the degree of freedom of a layout.

Further, in the case of (10) described above, it is possible to optimize the size of both of the first unit and the second unit, and it is possible to improve the efficiency and the degree of freedom of a layout.

Further, in the case of (11) described above, in comparison with a case where the number of the first antennas of the first unit is equal to the number of the third antennas of the second unit, the second unit can be smaller, and it is possible to improve the efficiency and the degree of freedom of a layout.

Further, in the case of (12) described above, in comparison with a case where the number of the first antennas of the first unit is equal to the number of the third antennas of the second unit, the first unit can be smaller, and it is possible to improve the efficiency and the degree of freedom of a layout.

Further, in the case of (13) or (14) described above, for example, it is possible to deal with a MIMO (Multiple Input and Multiple Output) transmission such as a 2×2 MIMO or a 4×4 MIMO and to improve the efficiency of wireless communication.

Further, in the case of (15) or (16) described above, for example, an antenna for emergency notification or the like can be arranged on the first unit which is not easily subject to a damage.

Further, in the case of (17) described above, for example, in comparison with a case where the second unit is arranged inside the vehicle, it is possible to reduce signal attenuation in the wireless communication by the second unit.

### BRIEF DESCRIPTION OF THE DRAWINGS

FIG. 1 is a schematic configuration view showing an arrangement example of a communication system according to an embodiment of the present invention.

FIG. 2 is a view showing an example of a configuration of a communication system according to the embodiment of the present invention.

FIG. 3 is a view showing an example of a configuration of a communication system according to a first modified example of the embodiment of the present invention.

FIG. 4 is a view showing an example of a configuration of a communication system according to a second modified example of the embodiment of the present invention.

FIG. 5 is a view showing an example of a configuration of a communication system according to a third modified example of the embodiment of the present invention.

FIG. 6 is a view showing an example of a configuration of a communication system according to a fourth modified example of the embodiment of the present invention.

FIG. 7 is a view showing an example of a configuration of a communication system according to a fifth modified example of the embodiment of the present invention.

FIG. 8 is a view showing an example of a configuration of a communication system according to a sixth modified example of the embodiment of the present invention.

FIG. 9 is a schematic configuration view showing an arrangement example of a communication system according to a seventh modified example of the embodiment of the present invention.

### DESCRIPTION OF THE EMBODIMENTS

Hereinafter, an embodiment of a communication system of the present invention will be described with reference to the accompanying drawings.

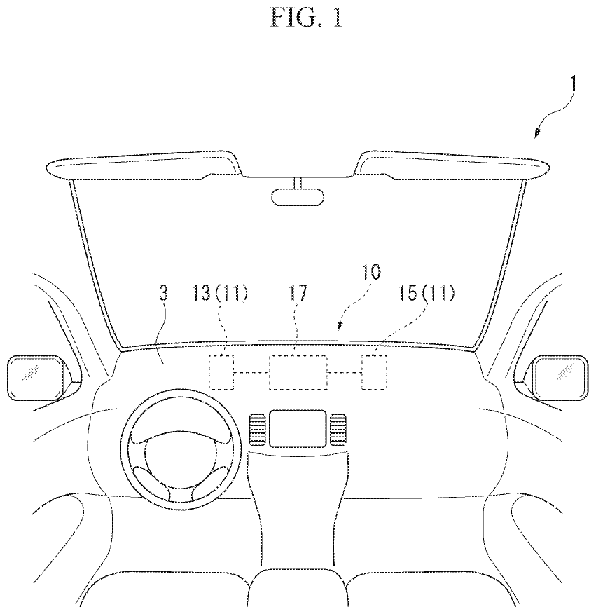

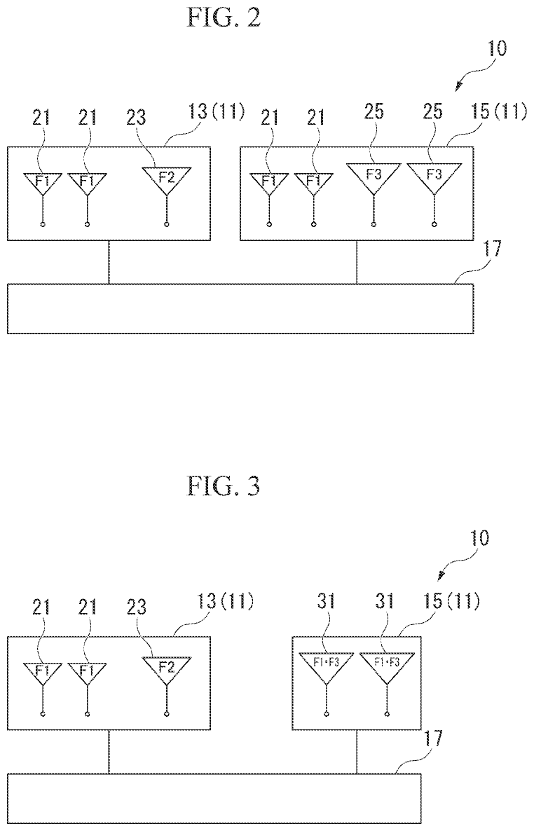

FIG. 1 is a schematic configuration view showing an arrangement example of a communication system 10 that includes an antenna unit 11 according to an embodiment of the present invention. FIG. 2 is a view showing an example of a configuration of the communication system 10 according to the embodiment of the present invention.

As shown in FIG. 1, the communication system 10 according to the present embodiment is mounted on the vehicle 1. The communication system 10 is arranged, for example, inside a dashboard (inside an instrument panel 2 or the like) in a vehicle room of the vehicle 1.

As shown in FIG. 1 and FIG. 2, the communication system 10 includes, for example, a first antenna unit 13 and a second antenna unit 15 that constitute the antenna unit 11, and a control device 17.

The first antenna unit 13 and the second antenna unit 15 are constituted, for example, as a separate body from the control device 17.

The first antenna unit 13 includes a plurality of first antennas 21 and a second antenna 23. For example, the first antenna unit 13 includes two first antennas 21 and one second antenna 23 inside a first housing (not shown).

The first antenna 21 is an antenna for wireless communication in a first frequency band F1. The first frequency band F1 is, for example, a frequency band such as a frequency band from 2 GHz to 5 GHz that corresponds to the standard of a fifth-generation mobile communication system (5G). An application of wireless communication in the first frequency band F1 is, for example, cellular communication or the like. The wireless communication in the first frequency band F1 is, for example, bidirectional communication.

The two first antennas 21 are used, for example, for a MIMO (Multiple Input and Multiple Output) transmission. The MIMO transmission is a spatial multiple transmission that combines a plurality of antennas and performs transmission and reception. The two first antennas 21 are, for example, combined with two first antennas 21 of the second antenna unit 15 described later and used for a 4×4 MIMO transmission that uses four antennas at each of a transmission side and a reception side.

The second antenna 23 is an antenna for wireless communication in a second frequency band F2. The application of wireless communication in the second frequency band F2 is, for example, different from the application of wireless communication in the first frequency band F1 and an application of wireless communication in a third frequency band F3 described later. The second antenna 23 is, for example, an antenna for receiving a positioning signal of a positioning system (Global Navigation Satellite System: GNSS or the like). The second frequency band F2 is, for example, a frequency band such as a 1 GHz band of a positioning signal.

The second antenna unit 15 includes a plurality of first antennas 21 and a plurality of third antennas 25. For example, the second antenna unit 15 includes two first antennas 21 and two third antennas 25 inside a second housing (not shown).

The third antenna 25 is an antenna for wireless communication in the third frequency band F3 which is lower than the first frequency band F1 and the second frequency band F2. The third frequency band F3 is, for example, a frequency band such as a frequency band from 700 MHz to 2 GHz that corresponds to the standard of a fourth-generation mobile communication system (4G). An application of wireless communication in the third frequency band F3 is, for example, common to the application of wireless communication in the first frequency band F1. The application of wireless communication in the third frequency band F3 is, for example, cellular communication or the like. The wireless communication in the third frequency band F3 is, for example, bidirectional communication.

The size of the third antenna 25 is formed, for example, to be larger than each size of the first antenna 21 and the second antenna 23.

The two third antennas 25 are, for example, used for a 2×2 MIMO transmission that uses two antennas at each of a transmission side and a reception side.

In the antenna unit 11, the third antenna 25 is provided only on the second antenna unit 15.

In the antenna unit 11, the first antenna 21 may be provided only on the first antenna unit 13 and the second antenna unit 15.

The control device 17 is connected to the first antenna unit 13, the second antenna unit 15, and a variety of devices that are mounted on the vehicle 1. The control device 17 is a software function unit that functions, for example, by a processor such as a CPU (Central Processing Unit) executing a predetermined program. The software function unit is an ECU (Electronic Control Unit) that includes a processor such as a CPU, a ROM (Read Only Memory) that stores a program, a RAM (Random Access Memory) that temporarily stores data, and an electronic circuit such as a timer. At least part of the control device 17 may be an integrated circuit such as a LSI (Large Scale Integration), an ASIC (Application Specific Integrated Circuit), a FPGA (Field-Programmable Gate Array), and a GPU (Graphics Processing Unit).

The control device 17 is, for example, a so-called TCU (Telematics Control Unit). The control device 17 controls transmission and reception of information by wireless communication and controls a variety of devices on the basis of the received information. For example, the control device 17 controls automatic notification at the time of emergency or the like, navigation, drive assist, diagnostics of an on-vehicle device (a battery or the like), and the like.

The control device 17 may include an antenna for a wireless LAN, an antenna for V2X communication (for example, inter-vehicle communication, road-to-vehicle communication, and the like), and the like.

Further, the control device 17 may be an IVI (In-Vehicle Infotainment: on-vehicle information communication) device such as a navigation device or a display audio.

As described above, according to the antenna unit 11 of the present embodiment, among the plurality of first antennas 21 and the plurality of third antennas 25, the plurality of first antennas 21 are arranged on the first antenna unit 13 and the second antenna unit 15, and the plurality of third antennas 25 are arranged on the second antenna unit 15. That is, in a case where the first antenna unit 13 and the second antenna unit 15 are constituted, for example, on the basis of the size and the shape of each of the antennas 21, 23, and 25 in accordance with the frequency band of wireless communication, the application of each of the antennas 21, 23, and 25, and the like, the plurality of first antennas 21 which are preferably distributed to each of the units 13 and 15, and the plurality of third antennas 25 which are preferably concentrated to one unit (that is, the second antenna unit 15) can be arranged in a distinguished manner, and the plurality of first antennas 21 can be preferably combined with the second antenna 23.

For example, by arranging the plurality of first antennas 21 and the second antenna 23 that have a similar frequency band of wireless communication on the first antenna unit 13 and by arranging the plurality of first antennas 21 and the third antenna 25 that have a similar application of wireless communication on the second antenna unit 15, it is possible to prevent the size of the first antenna unit 13 and the second antenna unit 15 as a whole from being increased and to improve a layout efficiency.

Further, the size of the third antenna 25 that corresponds to wireless communication of a lower frequency band than that of each of the first antenna 21 and the second antenna 23 is formed to be larger than each size of the first antenna 21 and the second antenna 23. Accordingly, by collectively arranging the plurality of third antennas 25 on one unit (that is, the second antenna unit 15), for example, in comparison with a case where the plurality of third antennas 25 are distributed to each of the units 13 and 15, it is possible to improve the efficiency and the degree of freedom of a layout and to prevent the size of the first antenna unit 13 and the second antenna unit 15 as a whole from being increased.

Further, since the number of the first antennas 21 provided on the first antenna unit 13 is equal to the number of the first antennas 21 provided on the second antenna unit 15, it is possible to optimize the size of both of the first antenna unit 13 and the second antenna unit 15, and it is possible to improve the efficiency and the degree of freedom of a layout.

Further, the number of the plurality of first antennas 21 and the number of the plurality of third antennas 25 of each of the units 13 and 15 are an even number, and thereby, for example, it is possible to deal with the MIMO transmission such as a 2×2 MIMO or a 4×4 MIMO and to improve the efficiency of wireless communication.

Further, the second antenna 23 used for acquiring position information of the vehicle 1 which is required, for example, for automatic notification at the time of emergency or the like can be arranged on the first antenna unit 13 inside the vehicle 1 that is not easily subject to damage.

Hereinafter, a modified example of the embodiment is described.

The above embodiment is described using an example in which the second antenna unit 15 includes the plurality of first antennas 21 and the plurality of third antennas 25; however, the embodiment is not limited thereto. The second antenna unit 15 may include a plurality of fourth antennas 31 instead of the plurality of first antennas 21 and the plurality of third antennas 25. FIG. 3 is a view showing an example of a configuration of a communication system 10 according to a first modified example of the embodiment of the present invention.

As shown in FIG. 3, in the communication system 10 according to the first modified example, the second antenna unit 15 includes, for example, two fourth antennas 31. The fourth antenna 31 is an antenna for wireless communication in the first frequency band F1 and the third frequency band F3. The size of the fourth antenna 31 is formed, for example, to be larger than the size of each of the first antenna 21 and the second antenna 23.

The two fourth antennas 31 are combined with the two first antennas 21 of the first antenna unit 13 and are used for the 4×4 MIMO transmission, for example, in wireless communication in the first frequency band F1. The two fourth antennas 31 are used for the 2×2 MIMO transmission, for example, in wireless communication in the third frequency band F3.

In the antenna unit 11 of the first modified example, the antennas for wireless communication in the third frequency band F3 are all the third antennas 25.

In the antenna unit 11 of the first modified example, only the first antenna unit 13 may include the first antenna 21.

According to the first modified example, among the plurality of first antennas 21 and the plurality of fourth antennas 31, the plurality of first antennas 21 together with the second antenna 23 are arranged on the first antenna unit 13, and the plurality of fourth antennas 31 are arranged on the second antenna unit 15. That is, in a case where the first antenna unit 13 and the second antenna unit 15 are constituted, for example, on the basis of the size and the shape of each of the antennas 21, 23, and 31 in accordance with the frequency band of wireless communication, the application of each of the antennas 21, 23, and 31, and the like, the plurality of first antennas which are preferably combined with the second antenna 23 and the plurality of fourth antennas 31 which are preferably collected with the same kind can be arranged in a distinguished manner. Thereby, it is possible to prevent the size of the first antenna unit 13 and the second antenna unit 15 as a whole from being increased and to improve a layout efficiency.

For example, by arranging the plurality of first antennas 21 and the second antenna 23 that have a similar frequency band of wireless communication on the first antenna unit 13 and by arranging the plurality of fourth antennas 31 that have a different application of wireless communication from that of the second antenna 23 on the second antenna unit 15, it is possible to prevent the size of the first antenna unit 13 and the second antenna unit 15 as a whole from being increased and to improve a layout efficiency.

Further, the size of the fourth antenna 31 that corresponds to wireless communication of a lower frequency band than that of each of the first antenna 21 and the second antenna 23 is formed to be larger than each size of the first antenna 21 and the second antenna 23. Accordingly, by collectively arranging the plurality of fourth antennas 31 on one unit (that is, the second antenna unit 15), for example, in comparison with a case where the plurality of fourth antennas 31 are distributed to each of the units 13 and 15, it is possible to improve the efficiency and the degree of freedom of a layout and to prevent the size of the first antenna unit 13 and the second antenna unit 15 as a whole from being increased.

Further, since the number of the first antennas 21 provided on the first antenna unit 13 is equal to the number of the fourth antennas 31 provided on the second antenna unit 15, it is possible to optimize the size of both of the first antenna unit 13 and the second antenna unit 15, and it is possible to improve the efficiency and the degree of freedom of a layout.

Further, the number of the plurality of first antennas 21 and the number of the plurality of fourth antennas 31 are an even number, and thereby, for example, it is possible to deal with the MIMO transmission such as a 2×2 MIMO or a 4×4 MIMO and to improve the efficiency of wireless communication.

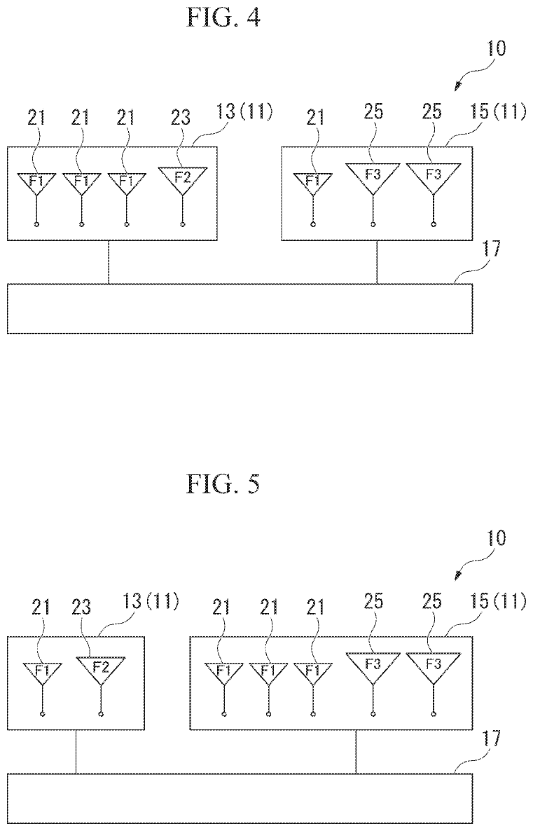

The above embodiment is described using an example in which the number of the first antennas 21 provided on the first antenna unit 13 is equal to the number of the first antennas 21 provided on the second antenna unit 15; however, the embodiment is not limited thereto. The number of the first antennas 21 provided on the first antenna unit 13 may be larger than the number of the first antennas 21 provided on the second antenna unit 15. FIG. 4 is a view showing an example of a configuration of a communication system 10 according to a second modified example of the embodiment of the present invention.

As shown in FIG. 4, in the communication system 10 according to the second modified example, the first antenna unit 13 includes, for example, three first antennas 21 and one second antenna 23 in an inside of a first housing (not shown). The second antenna unit 15 includes, for example, one first antenna 21 and two third antennas 25 in an inside of a second housing (not shown). At this time, the wireless communication in the first frequency band F1 may be a multiple I/O transmission in which the total number of antennas required for each of transmission and reception sides is four. For example, the three first antennas 21 of the first antenna unit 13 and the one first antenna 21 of the second antenna unit 15 may be combined and be used for a 4×4 MIMO transmission that uses four antennas at each of the transmission and reception sides.

According to the second modified example, in comparison with a case where the number of the first antennas 21 in the first antenna unit 13 is equal to the number of the first antennas 21 in the second antenna unit 15, the second antenna unit 15 can be smaller, and it is possible to improve the efficiency and the degree of freedom of a layout.

The above embodiment is described using an example in which the number of the first antennas 21 provided on the first antenna unit 13 is equal to the number of the first antennas 21 provided on the second antenna unit 15; however, the embodiment is not limited thereto. The number of the first antennas 21 provided on the first antenna unit 13 may be smaller than the number of the first antennas 21 provided on the second antenna unit 15. FIG. 5 is a view showing an example of a configuration of a communication system 10 according to a third modified example of the embodiment of the present invention.

As shown in FIG. 5, in the communication system 10 according to the third modified example, the first antenna unit 13 includes, for example, one first antenna 21 and one second antenna 23 in an inside of a first housing (not shown). The second antenna unit 15 includes, for example, three first antennas 21 and two third antennas 25 in an inside of a second housing (not shown). At this time, the wireless communication in the first frequency band F1 may be a multiple I/O transmission in which the total number of antennas required for each of transmission and reception sides is four. For example, the one first antenna 21 of the first antenna unit 13 and the three first antennas 21 of the second antenna unit 15 may be combined and be used for a 4×4 MIMO transmission that uses four antennas at each of the transmission and reception sides.

According to the third modified example, in comparison with a case where the number of the first antennas 21 in the first antenna unit 13 is equal to the number of the first antennas 21 in the second antenna unit 15, the first antenna unit 13 can be smaller, and it is possible to improve the efficiency and the degree of freedom of a layout.

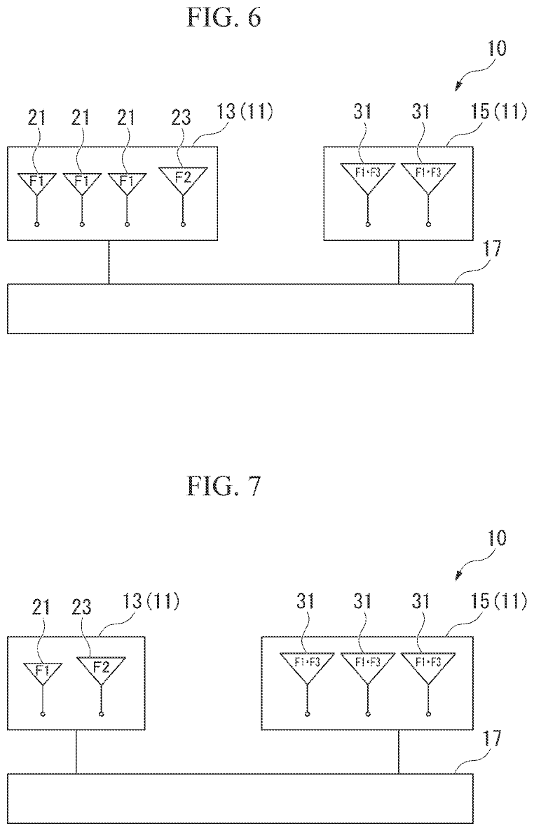

The above first modified example of the embodiment is described using an example in which the number of the first antennas 21 provided on the first antenna unit 13 is equal to the number of the fourth antennas 31 provided on the second antenna unit 15; however, the embodiment is not limited thereto. The number of the first antennas 21 provided on the first antenna unit 13 may be larger than the number of the fourth antennas 31 provided on the second antenna unit 15. FIG. 6 is a view showing an example of a configuration of a communication system 10 according to a fourth modified example of the embodiment of the present invention.

As shown in FIG. 6, in the communication system 10 according to the fourth modified example, the first antenna unit 13 includes, for example, three first antennas 21 and one second antenna 23 in an inside of a first housing (not shown). The second antenna unit 15 includes, for example, two fourth antennas 31 in an inside of a second housing (not shown). At this time, the wireless communication in the first frequency band F1 may be a multiple I/O transmission in which the total number of antennas required for each of transmission and reception sides is four. For example, the three first antennas 21 of the first antenna unit 13 and the two fourth antennas 31 of the second antenna unit 15 may be combined and be used for a 4×4 MIMO transmission that uses four antennas at each of the transmission and reception sides. In this case, the four antennas used for the 4×4 MIMO transmission may be, for example, four antennas having good communication quality selected from five or more antennas in total or the like.

According to the fourth modified example, in comparison with a case where the number of the first antennas 21 of the first antenna unit 13 is equal to the number of the fourth antennas 31 of the second antenna unit 15, it is possible to prevent the second antenna unit 15 from being increased in size, and it is possible to improve the efficiency and the degree of freedom of a layout.

The above first modified example of the embodiment is described using an example in which the number of the first antennas 21 provided on the first antenna unit 13 is equal to the number of the fourth antennas 31 provided on the second antenna unit 15; however, the embodiment is not limited thereto. The number of the first antennas 21 provided on the first antenna unit 13 may be smaller than the number of the fourth antennas 31 provided on the second antenna unit 15. FIG. 7 is a view showing an example of a configuration of a communication system 10 according to a fifth modified example of the embodiment of the present invention.

As shown in FIG. 7, in the communication system 10 according to the fifth modified example, the first antenna unit 13 includes, for example, one first antenna 21 and one second antenna 23 in an inside of a first housing (not shown). The second antenna unit 15 includes, for example, three fourth antennas 31 in an inside of a second housing (not shown). At this time, the wireless communication in the first frequency band F1 may be a multiple I/O transmission in which the total number of antennas required for each of transmission and reception sides is four. For example, the one first antenna 21 of the first antenna unit 13 and the three fourth antennas 31 of the second antenna unit 15 may be combined and be used for a 4×4 MIMO transmission that uses four antennas at each of the transmission and reception sides. Further, the wireless communication in the third frequency band F3 may be a multiple I/O transmission in which the total number of antennas required for each of transmission and reception sides is two. For example, two fourth antennas 31 having good communication quality selected from three fourth antennas 31 of the second antenna unit 15 or the like may be used for the 2×2 MIMO transmission that uses two antennas in each of the transmission and reception sides.

According to the fifth modified example, in comparison with a case where the number of the first antennas 21 of the first antenna unit 13 is equal to the number of the fourth antennas 31 of the second antenna unit 15, the first antenna unit 15 can be smaller, and it is possible to improve the efficiency and the degree of freedom of a layout.

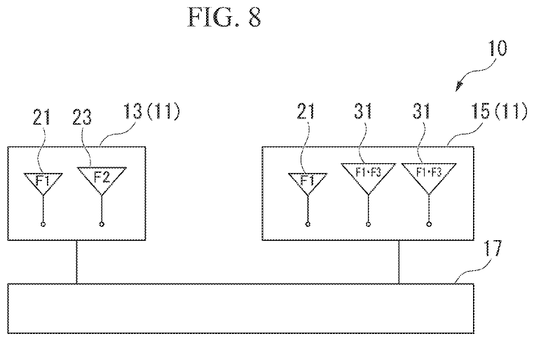

The above first modified example of the embodiment is described using an example in which the number of the first antennas 21 provided on the first antenna unit 13 is equal to the number of the fourth antennas 31 provided on the second antenna unit 15; however, the embodiment is not limited thereto. FIG. 8 is a view showing an example of a configuration of a communication system 10 according to a sixth modified example of the embodiment of the present invention.

As shown in FIG. 8, in the communication system 10 according to the sixth modified example, the first antenna unit 13 includes, for example, one first antenna 21 and one second antenna 23 in an inside of a first housing (not shown). The second antenna unit 15 includes, for example, two fourth antennas 31 and one first antenna 21 in an inside of a second housing (not shown). At this time, the wireless communication in the first frequency band F1 may be a multiple I/O transmission in which the total number of antennas required for each of transmission and reception sides is four. For example, the one first antenna 21 of the first antenna unit 13 and the one first antenna 21 and the two fourth antennas 31 of the second antenna unit 15 may be combined and be used for a 4×4 MIMO transmission that uses four antennas at each of the transmission and reception sides.

According to the sixth modified example, in comparison with a case where the number of the first antennas 21 of the first antenna unit 13 is equal to the number of the fourth antennas 31 of the second antenna unit 15, the first antenna unit 15 can be smaller, and it is possible to improve the efficiency and the degree of freedom of a layout.

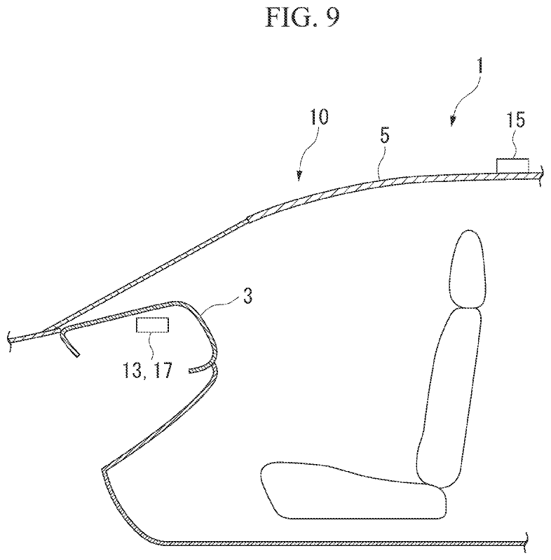

The above embodiment is described using an example in which the first antenna unit 13, the second antenna unit 15, and the control device 17 are arranged inside the dashboard (inside the instrument panel 2 or the like) in the vehicle room of the vehicle 1; however, the embodiment is not limited thereto. The first antenna unit 13, the second antenna unit 15, and the control device 17 and may be arranged on another area of the vehicle 1. FIG. 9 is a schematic configuration view showing an arrangement example of a communication system 10 that includes an antenna unit 11 according to a seventh modified example of the embodiment of the present invention.

As shown in FIG. 9, in the communication system 10 according to the seventh modified example, the first antenna unit 13 and the control device 17 are arranged inside the dashboard (inside the instrument panel 2 or the like) in the vehicle room of the vehicle 1. The second antenna unit 15 is arranged on a surface of an exterior member (for example, a roof 5 or the like) of the vehicle 1.

According to the seventh modified example, for example, in comparison with a case where the second antenna unit 15 is arranged inside the vehicle 1, it is possible to reduce signal attenuation in the wireless communication by the second antenna unit 15.

The above embodiment is described using an example in which the first antenna unit 13 and the second antenna unit 15 are constituted as a separate body from the control device 17; however, the embodiment is not limited thereto. For example, at least one of the first antenna unit 13 and the second antenna unit 15 may be constituted integrally with the control device 17 by being embedded in the control device 17 or the like.

Further, for example, the first antenna unit 13 may be constituted integrally with the control device 17 by being embedded in the control device 17 or the like, and the second antenna unit may be arranged on the surface of the exterior member (for example, the roof 5 or the like) of the vehicle 1.

The above-described embodiments are presented as examples and are not intended to limit the scope of the invention. The above-described novel embodiments can be implemented in various other forms, and a variety of omissions, replacements, or modifications can be made without departing from the scope of the invention. The above-described embodiments and modifications thereof are included in the scope of the invention and are included in the scope of the invention described in the claims and equivalents thereof.

### INDUSTRIAL APPLICABILITY

According to the present invention, it is possible to provide an antenna unit capable of preventing the size of the entire unit from being increased.

### DESCRIPTION OF THE REFERENCE SYMBOLS

1 Vehicle

2 Instrument panel

5 Roof (exterior member)

10 Communication system

11 Antenna unit

13 First antenna unit (first unit)

15 Second antenna unit (second unit)

17 Control device

21 First antenna

23 Second antenna

25 Third antenna

31 Fourth antenna (third antenna)

F1 First frequency band

F2 Second frequency band

F3 Third frequency band

What is claim is:

1. (canceled)

2. A communication system, comprising:
a first unit including a first antenna for wireless communication in a first frequency band and a second antenna for wireless communication in a second frequency band; and
a second unit including a third antenna for wireless communication in the first frequency band and a third frequency band,
wherein all antennas for wireless communication in the third frequency band are the third antenna.

3. The communication system according to claim 2,
wherein the third frequency band is lower than the first frequency band and the second frequency band.

4. The communication system according to claim 2,
wherein an application of wireless communication in the first frequency band and the third frequency band is different from an application of wireless communication in the second frequency band.

5. The communication system according to claim 4,
wherein the application of wireless communication in each of the first frequency band and the third frequency band is cellular communication, and
the application of wireless communication in the second frequency band is a positioning signal communication.

6. The communication system according to claim 4,
wherein the wireless communication in each of the first frequency band and the third frequency band is bidirectional communication, and
the wireless communication in the second frequency band is only reception.

7. (canceled)

8. (canceled)

9. (canceled)

10. The communication system according to claim 2,
wherein a number of the first antennas of the first unit is equal to a number of the third antennas of the second unit.

11. (canceled)

12. (canceled)

13. (canceled)

14. The communication system according to claim 10,
wherein the wireless communication in the first frequency band is a multiple I/O transmission in which a total number of antennas required for each of transmission and reception sides is four,
the wireless communication in the third frequency band is a multiple I/O transmission in which a total number of antennas required for each of transmission and reception sides is two,
a total number of the first antennas that the first unit includes is two, and a total number of the third antennas that the second unit includes is two.

15. The communication system according to claim 2,
wherein the first unit is arranged inside a vehicle.

16. The communication system according to claim 15,
wherein the first unit is arranged inside an instrument panel of the vehicle.

17. The communication system according to claim 15,
wherein the second unit is arranged on an exterior member of the vehicle.
